(19) United States
(12) Patent Application Publication
(10) Pub. No.: US 2026/0203507 A1
(43) Pub. Date: Jul. 16, 2026

(54) METHOD AND SYSTEM FOR PROVIDING INTENT-BASED INFORMATION INSIGHTS

(71) Applicant: LTI Mindtree Ltd, Mumbai (IN)

(72) Inventors: T Siva Rama Sarma, Mumbai (IN); Swarali Sudhir Thorat, Mumbai (IN); Sateesh Gottumukkala, Mumbai (IN); Ashish Varerkar, Mumbai (IN)

(21) Appl. No.: 19/239,967

(22) Filed: Jun. 17, 2025

(30) Foreign Application Priority Data
Jan. 16, 2025 (IN) 202521003709

(51) Int. Cl. G06F 40/30; G06F 40/103; G06F 40/166; G06F 40/40; G06T 11/26

(52) U.S. Cl. CPC G06F 40/30; G06F 40/103; G06F 40/166; G06F 40/40; G06T 11/26

(57) ABSTRACT

A method and system for providing intent-based information insights is disclosed. NLP techniques and a first LLM are applied to identify an intent vector associated with an input question received from a user. A plurality of paragraphs are retrieved from a document dataset based on relevancy to the intent vector. A graph representation of the plurality of paragraphs is generated. Importance score for each paragraph is determined based on centrality values derived from the graph representation, and similarity measures between the intent vector and the encoded paragraph vectors corresponding to each paragraph. A subset of sentences from the plurality of paragraphs is selected based on the determined importance scores through an iterative optimization process. A natural language summary is generated based on the subset of sentences using a second LLM and is presented to the user with explanatory indicators.

### FIELD

Various embodiments of the present disclosure generally relate to content summarization. More particularly, the disclosure relates to a method and system for providing intent-based content summarization and information insights using Artificial Intelligence (AI) and Natural Language Processing (NLP) techniques.

### BACKGROUND

The rapid and unrelenting expansion of digital information across a multitude of domains has resulted in an immense and constantly growing reservoir of data, encompassing everything from text documents and research articles to multimedia content and structured datasets. This exponential proliferation has fundamentally transformed the information landscape, making it increasingly difficult for individuals and organizations to efficiently locate, process, and synthesize meaningful insights from the deluge of content. The challenge lies not merely in accessing this information but in discerning the most relevant and valuable pieces of data from an overwhelming array of sources.

Information summarization methods, traditionally, that are designed to provide generalized overviews, often fall short in navigating this complexity. These methods tend to operate without a deep understanding of user-specific intents or the contextual subtleties that inform the relevance of certain pieces of information. Consequently, they produce outputs that, while potentially accurate in a broad sense, fail to align with the unique goals or needs of individual users.

When presented with a collection of documents in diverse formats alongside an intent statement that defines a specific area of interest, existing solutions often fall short in addressing the dual challenge of relevance and customization. The systems struggle to precisely extract the most pertinent paragraphs from the documents in alignment with the intent and fail to produce summaries that are specifically tailored to the nuances of the provided intent statement. The limitation results in generic outputs that do not effectively meet the user's information needs or contextual expectations, thereby reducing the overall utility of such solutions in intent-driven information retrieval and summarization tasks.

This lack of alignment leads to summaries that are either too vague or overly generic, providing limited utility for decision-making or actionable insights. For users seeking targeted information tailored to specific objectives, such shortcomings result in inefficiencies, as they must spend additional time and effort refining or augmenting the provided outputs.

Therefore, there is a need for a method and system that can highlight and fulfil this gap with methodologies that can go beyond traditional summarization by incorporating user intent and context into the summarization process, delivering outputs that are not only accurate but also highly relevant and purpose driven.

### SUMMARY

The present disclosure relates to a method and system for providing intent-based information insights. Natural language processing (NLP) techniques and a first large language model (LLM) are applied to identify an intent vector associated with an input question received from a user. A plurality of paragraphs are retrieved from a document dataset based on relevancy to the intent vector. A graph representation of the plurality of paragraphs is generated, where nodes of the graph representation represent the plurality of paragraphs and edges represent thematic relationships between the plurality of paragraphs. Importance score for each paragraph is determined based on centrality values derived from the graph representation, and similarity measures between the intent vector and the encoded paragraph vectors corresponding to each paragraph. A subset of sentences from the plurality of paragraphs is selected based on the determined importance scores through an iterative optimization process.

A natural language summary is generated based on the subset of sentences using a second LLM and is presented to the user with explanatory indicators identifying portions of the subset of sentences that contributed to the natural language summary.

One or more advantages of the prior art are overcome, and additional advantages are provided through the disclosure. In addition to illustrative aspects, embodiments, and features described above, further aspects, embodiments, and features will become apparent by reference to drawings and following detailed description.

### BRIEF DESCRIPTION OF THE FIGURES

FIG. 1 is a diagram that illustrates an exemplary environment within which various embodiments of the present disclosure may function.

FIG. 2 is a diagram that illustrates a system for providing intent-based information insights, in accordance with an embodiment of the disclosure.

FIG. 3 is a diagram that illustrates a flowchart for a method for providing intent-based information insights, in accordance with an embodiment of the disclosure.

### DESCRIPTION

Pursuant to various embodiments of the present disclosure, the method and system provides intent-based information insights. NLP techniques and a first LLM are applied to identify an intent vector associated with an input question received from a user. A plurality of paragraphs are retrieved from a document dataset based on relevancy to the intent vector. A graph representation of the plurality of paragraphs is generated, where nodes of the graph representation represent the plurality of paragraphs and edges represent thematic relationships between the plurality of paragraphs. Importance score for each paragraph is determined based on centrality values derived from the graph representation, and similarity measures between the intent vector and the encoded paragraph vectors corresponding to each paragraph. A subset of sentences from the plurality of paragraphs is selected based on the determined importance scores through an iterative optimization process.

A natural language summary is generated based on the subset of sentences using a second LLM and is presented to the user with explanatory indicators identifying portions of the subset of sentences that contributed to the natural language summary.

In one or more embodiments, the information insights refer to contextually relevant and intent-driven summaries or extracted information derived from a collection of documents. The insights are tailored to address specific user queries by leveraging NLP techniques and LLMs. The insights are designed to capture the relevance and diversity of the source content while aligning closely with the intent expressed by the user in their input question.

In one or more embodiments, the NLP techniques refer to a suite of computational methods and algorithms designed to process, analyze, and interpret human language in a manner that enables machines to understand, generate, and respond to textual data effectively. In the context of the present disclosure, NLP techniques are employed to analyze the input question provided by the user, extract its semantic meaning, and generate an intent vector that encapsulates the underlying purpose or goal of the query.

In one or more embodiments, the LLM refers to a neural network-based model trained on vast amounts of textual data to perform advanced natural language understanding and generation tasks. The LLM is capable of contextual comprehension, semantic analysis, and the generation of human-like text based on input prompts.

In one or more embodiments, the user refers to an individual or an entity seeking specific information or insights from a collection of documents. The user can be a researcher, data analyst, business professional, student, or any other individual who formulates an input question or query to gain meaningful, intent-driven summaries or information. Additionally, the user may also extend to automated systems or software agents that interact with the disclosed method and system to retrieve relevant insights based on predefined intent statements or programmatically generated queries.

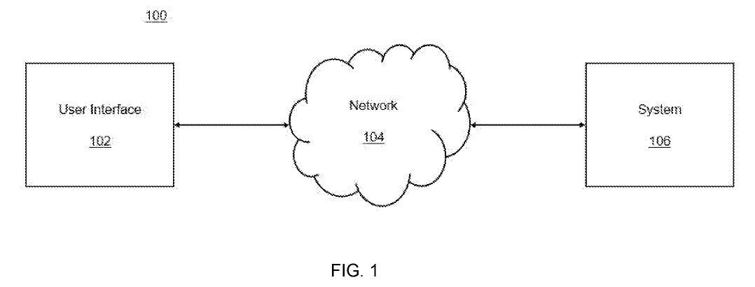

FIG. 1 is a diagram that illustrates an exemplary environment 100 within which various embodiments of the present disclosure may function. Referring to FIG. 1, the environment 100 comprises a user interface (UI) 102, a network 104, and a system 106.

The UI 102 is configured to receive an input question or a query from the user. The UI 102 is configured to receive input questions in various formats, such as text, voice, or other natural language inputs. The UI 102 facilitates the user to articulate the intent clearly and intuitively, providing mechanisms such as text boxes, speech-to-text conversion, or dropdown menus for predefined queries.

In one or more embodiments, the UI 102 is also configured to present an output generated by the system 106 of the present disclosure in a user-friendly format. The output may include, but is not limited to, a natural language summary tailored to the user's input question, explanatory indicators highlighting the contributory portions of the summarized content, and visualizations such as graphs or thematic maps to enhance the user's understanding of the presented insights.

The network 104 includes communication networks operable to facilitate communication, either wirelessly or wired. The network 104 connects a plurality of computer systems. The network 104 may comprise, for example, an intranet, local area network, wide area network, the internet, or other wireless networks.

The system 106 of the present disclosure is designed to extract the most relevant paragraphs from a plurality of documents based on a user-defined intent and generate summaries precisely tailored to the specific intent statement. The system 106 incorporates document pre-processing techniques to standardize diverse document formats, converting them into plain text and segmenting them into manageable paragraphs. Using NLP techniques, including sentence encoding and similarity measures, the system 106 identifies content that aligns closely with the intent. To rank and organize the paragraphs, the system 106 employs graph-based methodologies, where nodes represent paragraphs, and edges signify thematic relationships, enabling a structured analysis of content importance. An iterative optimization process, guided by genetic algorithms, is used to select sentences that are both highly relevant to the intent and diverse in content, for comprehensive coverage. Finally, generative AI models create a cohesive and contextually appropriate summary. To enhance transparency, the system 106 includes an explainability layer, which utilizes an adaptation of the LIME (Local Interpretable Model-agnostic Explanations) framework tailored to generative AI applications. The adaptation is designed for intent-based document summarization, enabling the system 106 to highlight influential input components with respect to the user-defined intent.

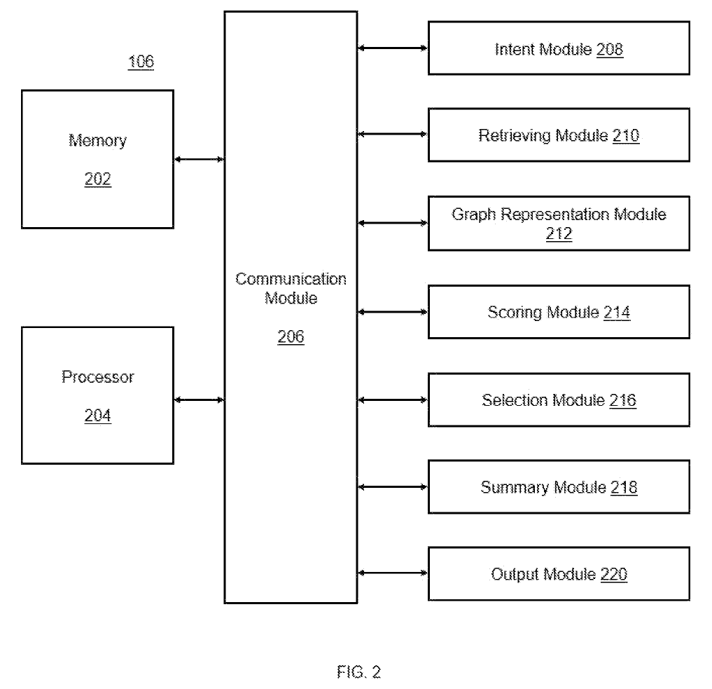

FIG. 2 is a diagram that illustrates a block diagram of the system 106 for providing intent-based information insights, in accordance with an embodiment of the disclosure. Referring to FIG. 2, the system 106 includes a memory 202, a processor 204, a communication module 206, an intent module 208, a retrieving module 210, a graph representation module 212, a scoring module 214, a selection module 216, a summary module 218, and an output module 220.

The memory 202 may comprise suitable logic, and/or interfaces, that may be configured to store instructions (for example, computer-readable program code) that can implement various aspects of the present disclosure.

The processor 204 may comprise suitable logic, interfaces, and/or code that may be configured to execute the instructions stored in the memory 202 to implement various functionalities of the system 106 in accordance with various aspects of the present disclosure. The communication module 206 is configured to facilitate seamless interaction between the processor 204 and various modules within the system 106.

Upon receiving an input question from the user through the UI 102, the intent module 208 of the system 106, equipped with appropriate logic, code, and interfaces, is configured to perform an in-depth analysis of the input question to determine the underlying intent. Utilizing NLP techniques, the intent module 208 processes the semantic, syntactic, and contextual nuances of the input question, which may involve tokenizing the input, identifying key phrases, and analyzing the linguistic structure to derive meaningful patterns.

The intent module 208 then employs the first LLM, which leverages its training on diverse textual data, to generate an intent vector, a multidimensional representation of the user's query. The intent vector acts as a mathematical abstraction that aligns the user's question with the broader semantic context of document dataset.

The retrieving module 210 may comprise suitable logic, code, and/or interfaces that may be configured to retrieve a plurality of paragraphs from a document dataset, based on relevancy to the intent vector.

In one or more embodiments, the document dataset is pre-processed and organized to include encoded paragraph vectors, which are mathematical representations of the paragraphs. The paragraph vectors capture the semantic essence of the content, enabling the retrieving module 210 to perform a precise matching process.

In one or more embodiments, a plurality of documents are preprocessed to generate the encoded paragraph vectors, prior to storing them in the document dataset. The preprocessing may involve several steps designed to standardize and optimize the documents for efficient retrieval and analysis. Initially, the documents are converted into a uniform format, for compatibility across diverse file types. The content is then segmented into individual paragraphs, each representing a coherent unit of information. To encode the paragraphs, NLP techniques are applied, utilizing models trained on large-scale text corpora, which generate paragraph vectors. The encoded vectors are then stored in the document dataset, enabling the system 106 to perform similarity comparisons with the intent vector.

In one or more embodiments, each document from the plurality of documents undergoes a preprocessing phase. Initially, each document is converted into plain text, stripping away formatting, metadata, and other non-essential elements to focus solely on the textual content. Once converted, the plain text document is segmented into a respective set of paragraphs, with each paragraph representing a distinct and coherent unit of information.

To capture the semantic meaning and contextual relationships of each paragraph, vector representations are generated using a sentence encoder model, that is trained on diverse textual datasets. The sentence encoder model encodes each paragraph into a high-dimensional vector representation that encapsulates its linguistic and contextual attributes. The vector representations, referred to as encoded paragraph vectors, are then stored in the document dataset.

In one or more embodiments, preprocessing the plurality of documents involves a series of steps to prepare the data for efficient analysis and retrieval. Initially, non-textual elements, such as images, tables, annotations, and metadata, are identified and removed from each document, to make the system 106 focus on the textual content relevant to the intent-based analysis. Additionally, text formatting across the plurality of documents is normalized, standardizing font styles, cases, and special characters to maintain consistency and enhance processing accuracy.

In one or more embodiments, duplicate paragraphs are identified and filtered out to eliminate redundancy within the dataset, to reduce storage requirements and improve the efficiency and quality of subsequent retrieval operations by ensuring that each paragraph in the dataset provides unique and meaningful information. Once the preprocessing is complete, the system 106 generates vector representations for the remaining paragraphs, capturing their semantic essence for subsequent use in intent-based content retrieval.

The graph representation module 212 may comprise suitable logic, code, and/or interfaces configured to generate a graph representation of the plurality of paragraphs retrieved from the document dataset.

In one or more embodiments, the graph representation is constructed such that the nodes correspond to the individual paragraphs, representing discrete units of information within the retrieved set. The edges of the graph signify thematic relationships between the paragraphs, determined through similarity metrics, co-occurrence of keywords, or shared contextual relevance. By organizing the paragraphs into this interconnected structure, the graph representation module 212 may facilitate operations such as centrality analysis, clustering, and thematic ranking.

In one or more embodiments, the graph representation module 212 is configured to calculate pairwise similarity scores between the encoded paragraph vectors to capture the thematic relationships between the paragraphs. The pairwise similarity scores are determined using a similarity metric such as cosine similarity, which evaluates the angular similarity between vector representations of the paragraphs.

Based on the calculated pairwise similarity scores, the graph representation module 212 establishes edges between pairs of nodes in the graph representation. Each node in the graph corresponds to a paragraph from the plurality of paragraphs, and an edge is established between two nodes when the similarity score of their corresponding encoded paragraph vectors exceeds a predetermined threshold.

In one or more embodiments, once the edges are established, the graph representation module 212 assigns weights to these edges. The weights are directly proportional to the pairwise similarity scores, with higher scores resulting in heavier edge weights. The weighted edges indicate the strength of the thematic relationship between connected paragraphs, enabling a more nuanced analysis of the graph for downstream processes such as centrality calculation and paragraph ranking.

The scoring module 214 may comprise suitable logic, code, and/or interfaces configured to assign importance scores to each paragraph within the plurality of retrieved paragraphs. The scoring process leverages insights derived from the graph representation generated by the graph representation module 212 and integrates semantic relevance for a robust evaluation.

Specifically, in one or more embodiments, the scoring module 214 calculates centrality values for each node (representing a paragraph) in the graph representation. The centrality values reflect the relative significance of each paragraph within the thematic structure of the graph, based on factors such as the number and weight of edges connected to the node. Central paragraphs with stronger or more numerous thematic links to other paragraphs are assigned higher centrality values.

Additionally, the scoring module 214 evaluates the similarity between the intent vector, representing the user’s query or focus, and the encoded paragraph vectors corresponding to each paragraph. The similarity measure quantifies how closely the semantic content of each paragraph aligns with the user’s intent.

In one or more embodiments, the scoring module 214 determines the importance scores by employing a two-step process. The first step involves applying a graph centrality algorithm to the graph representation generated by the graph representation module 212. The graph centrality algorithm evaluates the structural significance of each node (paragraph) within the graph by analyzing its connectivity to other nodes. The resulting centrality values quantify the relative importance of each paragraph within the thematic context of the entire set, identifying key paragraphs that serve as pivotal connectors or thematic hubs.

The second step involves calculating similarity measures to assess the semantic relevance of each paragraph to the user's intent. Cosine similarity is computed between the intent vector representing the user's input question or focus and each encoded paragraph vector stored in the document dataset. Cosine similarity effectively measures the angle between two vectors in high-dimensional space, with higher values indicating stronger alignment between the semantic content of the paragraph and the intent.

The selection module 216 may comprise suitable logic, code, and/or interfaces that may be configured to select a subset of sentences from the plurality of paragraphs based on the determined importance score, through an iterative optimization process.

In one or more embodiments, the iterative optimization process leverages advanced computational techniques, such as genetic algorithms or heuristic search methods, to balance competing objectives. The primary objective is to maximize the relevance of the selected sentences to the user's intent, as indicated by the similarity measures between the sentences and the intent vector. Simultaneously, the iterative optimization process enables content diversity by promoting the inclusion of sentences that provide distinct yet complementary perspectives on the topic.

In one or more embodiments, the iterative optimization process operates by maintaining a dynamic set of candidate sentence combinations derived from the plurality of paragraphs. The iterative optimization process systematically refines the combinations to achieve an optimal balance between relevance to the intent vector and diversity among the selected sentences. The iterative optimization process begins by calculating a relevance score for each candidate combination, where the relevance score is determined based on a fitness function designed for the genetic algorithm to evaluate the relevance and quality of a collection of sentences in relation to the user’s intent. The fitness function integrates multiple metrics for assessment: bert_similarity measures the semantic similarity between the intent and the sentences using BERT embeddings; sentence_coherence evaluates the logical flow between sentences; tfidf_scores determine the importance of terms in the sentences relative to the intent using term frequency-inverse document frequency; entity_matching checks for the presence of key entities from the intent within the sentences; and mmr_scores (Maximal Marginal Relevance) balance the relevance and diversity of the sentences. Each metric is assigned a predefined weight reflecting its importance, and their weighted sum forms the overall relevance score, which guides the genetic algorithm in selecting the most relevant, coherent, and diverse sentences for intent-based summarization. Simultaneously, the iterative optimization process evaluates the semantic differences between sentences within each combination to assign a diversity score.

Subsequently, the iterative optimization process identifies and selects candidate combinations that exhibit the highest combined relevance and diversity scores. Using these top-performing combinations, the iterative optimization process generates new candidate combinations through recombination or modification techniques, such as crossover and mutation strategies commonly employed in genetic algorithms. This iterative cycle of evaluation, selection, and generation continues until a predetermined optimization criterion is satisfied, such as achieving a convergence threshold for scores or reaching a maximum number of iterations.

The summary module 218 comprises suitable logic, code, and/or interfaces that may be configured to generate a natural language summary based on the subset of sentences using a second LLM. The second LLM may be fine-tuned or pre-trained on summarization tasks to make sure the generated summary is concise and tailored to the identified intent vector.

In one or more embodiments, the summary module 218 structures the subset of sentences into a narrative flow, enhancing readability and ensuring the summary accurately captures the core themes and insights relevant to the input question. The second LLM applies advanced generative techniques to rephrase, organize, and consolidate the content of the selected sentences, producing a fluent and semantically rich summary.

In one or more embodiments, generating the natural language summary by the summary module 218 involves arranging the subset of sentences in a logical and coherent order that reflects their thematic relationships to make sure that the summary follows a structured narrative flow, enhancing readability and comprehension. The subset of sentences, organized based on thematic relationships, is provided as input to the second LLM along with the intent vector to guide the summary generation process.

In one or more embodiments, by incorporating the intent vector, the summary module 218 confirms that the generated natural language summary remains aligned with the user's specific intent and highlights the most relevant insights from the subset of sentences. The second LLM processes the input to produce a semantically consistent summary that integrates the arranged subset of sentences with contextual nuances derived from the intent vector.

In one or more embodiments, identifying the portions of the subset of sentences that contributed to the natural language summary involves leveraging an explainability framework to analyze the relationships and dependencies between the subset of sentences and the generated summary. The analysis provides a detailed understanding of how individual sentences, or their specific parts, influence the composition of the summary.

In one or more embodiments, the process involves assigning contribution weights to different portions of the subset of sentences based on their impact on the semantic and contextual consistency of the summary. The weights quantify the relative importance of each sentence or sentence fragment in shaping the final summary. Subsequently, the determined contribution weights are utilized to generate explanatory indicators.

The output module 220 may be configured to output the natural language summary with explanatory indicators identifying portions of the subset of sentences that contributed to the natural language summary. The indicators pinpoint specific portions of the subset of sentences selected during the processing stages that directly contributed to generating the natural language summary.

In one or more embodiments, the output module 220 utilizes an explainability layer, which utilizes an adaptation of frameworks such as LIME, SHAP (SHapley Additive exPlanations), or any custom algorithm, tailored to generative AI applications, to analyze the relationships between the subset of sentences and the generated summary. During this process, the output module 220 assigns contribution weights to different portions of the subset of sentences, based on their influence on specific segments of the natural language summary. The weights are then used to annotate or highlight the relevant portions of the sentences.

### Exemplary embodiment

Consider a scenario where a user, a market analyst, is researching the latest trends in renewable energy adoption worldwide. The user inputs the question,

"What are the key drivers of renewable energy adoption globally?"

into the UI 102. The system 106 processes this input using the modules described in the present disclosure to generate a natural language summary tailored to this query.

The input question is first processed by the intent module 208, which uses NLP techniques and a first LLM to generate an intent vector representing the user’s query. For this example, the intent vector encapsulates the themes of "renewable energy," "adoption," and "key drivers," emphasizing global perspective.

The retrieving module 210 accesses a document dataset containing policy reports, scientific publications, and news articles on renewable energy. Using the intent vector, the retrieving module 210 retrieves a set of paragraphs from the dataset most relevant to the themes of the query. For example, the retrieved paragraphs may discuss government subsidies, technological advancements, environmental policies, and cost reductions in renewable energy.

The graph representation module 212 converts the retrieved paragraphs into a graph representation.

Nodes in the graph correspond to the retrieved paragraphs. Edges are established based on pairwise similarity scores between the encoded paragraph vectors, calculated using cosine similarity.

Edge weights reflect the thematic similarity between paragraphs. For instance, paragraphs discussing "government incentives" and "policy frameworks" are thematically related and have a high edge weight.

The scoring module 214 determines the importance scores for each paragraph.

It calculates centrality values for the graph nodes using a graph centrality algorithm, such as PageRank, to identify paragraphs that are thematically central.

It also computes similarity scores between the intent vector and each paragraph’s encoded vector. For example, a paragraph emphasizing the role of global environmental agreements may receive a high importance score due to both centrality and its direct relevance to the intent vector.

The selection module 216 iteratively identifies a subset of sentences from the paragraphs to maximize both relevance to the intent vector and diversity of content.

For instance, the selected sentences may highlight different drivers:

“Government subsidies have significantly increased renewable energy adoption rates in developing countries .”

“ Technological advancements have made solar energy more affordable and accessible globally .”

“ International agreements such as the Paris Accord encourage nations to adopt renewable energy to reduce carbon emissions.”

The summary module 218 arranges the selected sentences in a coherent order based on their thematic relationships. The arranged sentences, along with the intent vector, are provided as input to a second LLM, which generates a natural language summary.

For example, the generated summary:

Renewable energy adoption worldwide is driven by several key factors. Government subsidies in developing nations have accelerated adoption rates. Technological advancements, particularly in solar and wind energy, have reduced costs and increased accessibility. Additionally, international agreements like the Paris Accord play a crucial role in motivating countries to adopt renewable energy as part of global efforts to combat climate change.

The output module 220 applies an explainability framework to identify portions of the subset of sentences contributing to the summary. Contribution weights are calculated, and explanatory indicators are added to the output. For instance:

“Government subsidies have significantly increased renewable energy adoption rates in developing countries.”

(High contribution to the first sentence of the summary.)

“Technological advancements have made solar energy more affordable and accessible globally.”

(Key contribution to the second sentence.)

The summary with explanatory indicators is then presented to the user via the UI 102, providing a transparent, concise, and intent-specific insight into the query.

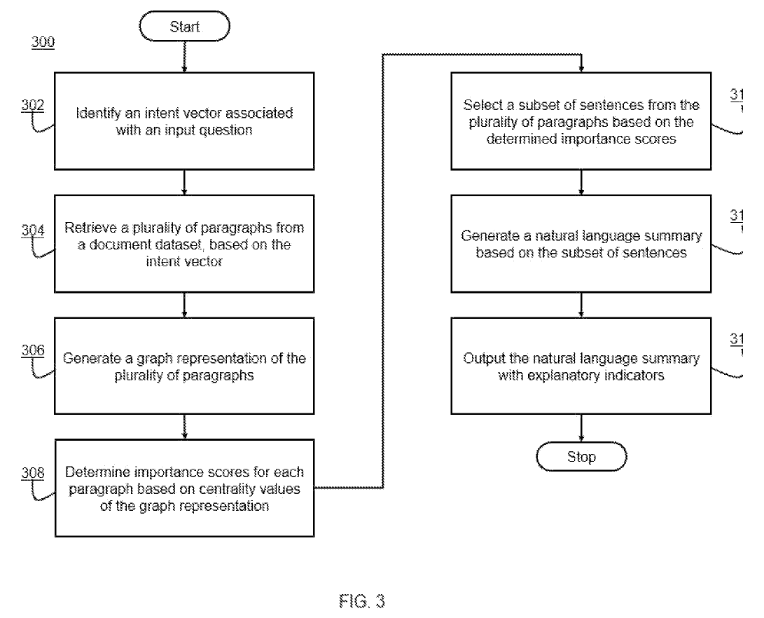

FIG. 3 is a diagram that illustrates a flowchart 300 for a method for providing intent-based information insights, in accordance with an embodiment of the disclosure.

At 302, upon receiving an input question from the user, the intent module 208 performs an in-depth analysis of the input question to determine the underlying intent. Utilizing NLP techniques and a first LLM, the intent module 208 processes the semantic, syntactic, and contextual nuances of the input question, which may involve tokenizing the input, identifying key phrases, and analyzing the linguistic structure to derive meaningful patterns.

The intent module 208 then employs the first LLM, which leverages its training on diverse textual data, to generate an intent vector, a multidimensional representation that encapsulates the essence of the user's query. The intent vector acts as a mathematical abstraction that aligns the user's question with the broader semantic context of document dataset.

At 304, the retrieving module 210 retrieves a plurality of paragraphs from a document dataset, based on relevancy to the identified intent vector.

In one or more embodiments, the document dataset is pre-processed and organized to include encoded paragraph vectors, which are mathematical representations of the paragraphs. The paragraph vectors capture the semantic essence of the content, enabling the retrieving module 210 to perform a precise matching process.

In one or more embodiments, a plurality of documents are preprocessed to generate the encoded paragraph vectors, prior to storing them in the document dataset. The preprocessing may involve several steps designed to standardize and optimize the documents for efficient retrieval and analysis. Initially, the documents are converted into a uniform format, for compatibility across diverse file types. The content is then segmented into individual paragraphs, each representing a coherent unit of information. To encode the paragraphs, NLP techniques are applied, utilizing models trained on large-scale text corpora. These models generate paragraph vectors. The encoded vectors are then stored in the document dataset, enabling the system 106 to perform rapid and accurate similarity comparisons with the intent vector.

In one or more embodiments, each document from the plurality of documents undergoes a preprocessing phase for consistency and facilitate efficient analysis. Initially, each document is converted into plain text, stripping away formatting, metadata, and other non-essential elements to focus solely on the textual content. Once converted, the plain text document is segmented into a respective set of paragraphs, with each paragraph representing a distinct and coherent unit of information.

To capture the semantic meaning and contextual relationships of each paragraph, vector representations are generated using a sentence encoder model, that is trained on diverse textual datasets. The sentence encoder model encodes each paragraph into a high-dimensional vector representation that encapsulates its linguistic and contextual attributes. The vector representations, referred to as encoded paragraph vectors, are then stored in the document dataset.

In one or more embodiments, preprocessing the plurality of documents involves a series of steps to prepare the data for efficient analysis and retrieval. Initially, non-textual elements, such as images, tables, annotations, and metadata, are identified and removed from each document, to make the system 106 focus on the textual content relevant to the intent-based analysis. Additionally, text formatting across the plurality of documents is normalized, standardizing font styles, cases, and special characters to maintain consistency and enhance processing accuracy.

In one or more embodiments, duplicate paragraphs are identified and filtered out to eliminate redundancy within the dataset, to reduce storage requirements and improve the efficiency and quality of subsequent retrieval operations by ensuring that each paragraph in the dataset provides unique and meaningful information. Once the preprocessing is complete, the system 106 generates vector representations for the remaining paragraphs, capturing the semantic essence for subsequent use in intent-based content retrieval.

At 306, a graph representation of the plurality of paragraphs retrieved from the document dataset is generated using the graph representation module 212. In one or more embodiments, the graph representation is constructed such that the nodes correspond to the individual paragraphs, representing discrete units of information within the retrieved set. The edges of the graph signify thematic relationships between the paragraphs, determined through similarity metrics, co-occurrence of keywords, or shared contextual relevance. By organizing the paragraphs into this interconnected structure, the graph representation module 212 may facilitate operations such as centrality analysis, clustering, and thematic ranking.

In one or more embodiments, the graph representation module 212 is configured to calculate pairwise similarity scores between the encoded paragraph vectors to capture the thematic relationships between the paragraphs. The pairwise similarity scores are determined using a similarity metric such as cosine similarity, which evaluates the angular similarity between vector representations of the paragraphs.

Based on the calculated pairwise similarity scores, the graph representation module 212 establishes edges between pairs of nodes in the graph representation. Each node in the graph corresponds to a paragraph from the plurality of paragraphs, and an edge is established between two nodes when the similarity score of their corresponding encoded paragraph vectors exceeds a predetermined threshold.

In one or more embodiments, once the edges are established, the graph representation module 212 assigns weights to these edges. The weights are directly proportional to the pairwise similarity scores, with higher scores resulting in heavier edge weights. The weighted edges indicate the strength of the thematic relationship between connected paragraphs, enabling a more nuanced analysis of the graph for downstream processes such as centrality calculation and paragraph ranking.

At 308, importance scores are assigned to each paragraph within the plurality of retrieved paragraph, by the scoring module 214. The scoring process leverages insights derived from the graph representation generated by the graph representation module 212 and integrates semantic relevance for a robust evaluation.

Specifically, in one or more embodiments, the scoring module 214 calculates centrality values for each node (representing a paragraph) in the graph representation. The centrality values reflect the relative significance of each paragraph within the thematic structure of the graph, based on factors such as the number and weight of edges connected to the node. Central paragraphs with stronger or more numerous thematic links to other paragraphs are assigned higher centrality values.

In one or more embodiments, the scoring module 214 determines the importance scores by employing a two-step analytical process. The first step involves applying a graph centrality algorithm to the graph representation generated by the graph representation module 212. The graph centrality algorithm evaluates the structural significance of each node (paragraph) within the graph by analyzing its connectivity to other nodes. The resulting centrality values quantify the relative importance of each paragraph within the thematic context of the entire set, identifying key paragraphs that serve as pivotal connectors or thematic hubs.

The second step involves calculating similarity measures to assess the semantic relevance of each paragraph to the user's intent. In this step, cosine similarity is computed between the intent vector representing the user's input question or focus and each encoded paragraph vector stored in the document dataset. Cosine similarity effectively measures the angle between two vectors in high-dimensional space, with higher values indicating stronger alignment between the semantic content of the paragraph and the intent.

At 310, the selection module 216 selects a subset of sentences from the plurality of paragraphs based on the determined importance score, through an iterative optimization process. In one or more embodiments, the iterative optimization process leverages advanced computational techniques, such as genetic algorithms or heuristic search methods, to balance competing objectives. The primary objective is to maximize the relevance of the selected sentences to the user's intent, as indicated by the similarity measures between the sentences and the intent vector. Simultaneously, the iterative optimization process enables content diversity by promoting the inclusion of sentences that provide distinct yet complementary perspectives on the topic.

In one or more embodiments, the iterative optimization process operates by maintaining a dynamic set of candidate sentence combinations derived from the plurality of paragraphs. The iterative optimization process systematically refines the combinations to achieve an optimal balance between relevance to the intent vector and diversity among the selected sentences. The iterative optimization process begins by calculating a relevance score for each candidate combination, where the relevance score is determined based on a fitness function designed for the genetic algorithm to evaluate the relevance and quality of a collection of sentences in relation to the user’s intent. The fitness function integrates multiple metrics for assessment: bert_similarity measures the semantic similarity between the intent and the sentences using BERT embeddings; sentence_coherence evaluates the logical flow between sentences; tfidf_scores determine the importance of terms in the sentences relative to the intent using term frequency-inverse document frequency; entity_matching checks for the presence of key entities from the intent within the sentences; and mmr_scores (Maximal Marginal Relevance) balance the relevance and diversity of the sentences. Each metric is assigned a predefined weight reflecting its importance, and their weighted sum forms the overall relevance score, which guides the genetic algorithm in selecting the most relevant, coherent, and diverse sentences for intent-based summarization.

Subsequently, the iterative optimization process identifies and selects candidate combinations that exhibit the highest combined relevance and diversity scores. Using these top-performing combinations, the process generates new candidate combinations through recombination or modification techniques, such as crossover and mutation strategies commonly employed in genetic algorithms. The iterative cycle of evaluation, selection, and generation continues until a predetermined optimization criterion is satisfied, such as achieving a convergence threshold for scores or reaching a maximum number of iterations.

At 312, a natural language summary is generated by the summary module 218 based on the subset of sentences using a second LLM. In one or more embodiments, the summary module 218 structures the subset of sentences into a logical narrative flow, enhancing readability and ensuring the summary accurately captures the core themes and insights relevant to the input question. The second LLM applies advanced generative techniques to rephrase, organize, and consolidate the content of the selected sentences, producing a fluent and semantically rich summary.

In one or more embodiments, generating the natural language summary by the summary module 218 involves arranging the subset of sentences in a logical and coherent order that reflects their thematic relationships to make sure that the summary follows a structured narrative flow, enhancing readability and comprehension. The subset of sentences, organized based on thematic relationships, is provided as input to the second LLM along with the intent vector to guide the summary generation process.

In one or more embodiments, by incorporating the intent vector, the summary module 218 confirms that the generated natural language summary remains aligned with the user's specific intent and highlights the most relevant insights from the subset of sentences. The second LLM processes the input to produce a semantically consistent summary that integrates the arranged subset of sentences with contextual nuances derived from the intent vector.

At 314, the output module 220 outputs the natural language summary with explanatory indicators identifying portions of the subset of sentences that contributed to the natural language summary. The indicators pinpoint specific portions of the subset of sentences selected during the processing stages that directly contributed to generating the natural language summary.

The method and system is advantageous in that it enables more precise and relevant information extraction through the combination of intent vector generation and graph-based content analysis, where the intent vector ensures alignment with user requirements while the graph representation captures complex thematic relationships between content segments, resulting in more contextually appropriate and meaningful insights compared to traditional summarization approaches.

Further, the method and system provides superior content selection through its multi-objective optimization approach that simultaneously maximizes both relevance to user intent and content diversity, enabling generation of comprehensive summaries that cover all important aspects while maintaining focus on the specific user requirements, thereby overcoming limitations of conventional systems that often produce either overly focused or too general summaries.

Furthermore, the method and system achieves enhanced summary quality through its context-aware generation approach that maintains semantic consistency between the selected content and user intent, resulting in more coherent and usable summaries that better preserve the thematic relationships present in the source content while remaining aligned with the user's specific information needs.

Additionally, the method and system provides improved transparency in AI-generated summaries through its integrated explainability framework that clearly identifies how different content portions contribute to the final summary, enabling users to better understand and verify the system's output, thereby addressing the critical limitation of "black box" behavior in traditional AI-based summarization systems.

Those skilled in the art will realize that the above-recognized advantages and other advantages described herein are merely exemplary and are not meant to be a complete rendering of all of the advantages of the various embodiments of the present disclosure.

In the foregoing complete specification, specific embodiments of the present disclosure have been described. However, one of the ordinary skill in the art appreciates that various modifications and changes can be made without departing from the scope of the present disclosure. Accordingly, the specification and figures are to be regarded in an illustrative rather than a restrictive sense. All such modifications are intended to be included within the scope of the present disclosure.

What is claimed is:

1. A computer-implemented method for providing intent-based information insights, comprising:
receiving, by a processor, an input question from a user;
identifying, by the processor, using natural language processing techniques and a first large language model (LLM), an intent vector associated with the input question;
retrieving, from a document dataset, a plurality of paragraphs based on relevancy to the intent vector, wherein the document dataset comprises encoded paragraph vectors;
generating, by the processor, a graph representation of the plurality of paragraphs, wherein nodes of the graph representation represent the plurality of paragraphs and edges represent thematic relationships between the plurality of paragraphs;
determining, by the processor, importance scores for each paragraph of the plurality of paragraphs based on centrality values derived from the graph representation, and similarity measures between the intent vector and the encoded paragraph vectors corresponding to each paragraph;
selecting, by the processor through an iterative optimization process, a subset of sentences from the plurality of paragraphs based on the determined importance scores, wherein the iterative optimization process maximizes both relevance to the intent vector and content diversity among the subset of sentences;
generating, by the processor using a second LLM, a natural language summary based on the subset of sentences; and
outputting, to the user, the natural language summary with explanatory indicators identifying portions of the subset of sentences that contributed to the natural language summary.

2. The method of claim 1, further comprising preprocessing, prior to storing in the document dataset, a plurality of documents to generate the encoded paragraph vectors, wherein preprocessing comprises:
converting each document of the plurality of documents into plain text;
segmenting each document into a respective set of paragraphs;
generating, using a sentence encoder model, vector representations for each paragraph; and
storing the vector representations as the encoded paragraph vectors in the document dataset.

3. The method of claim 2, wherein preprocessing the plurality of documents further comprises:
identifying and removing non-textual elements from each document;
normalizing text formatting across the plurality of documents; and
filtering out duplicate paragraphs prior to generating the vector representations.

4. The method of claim 1, wherein determining the importance scores comprises:
applying a graph centrality algorithm to the graph representation to calculate the centrality values for each paragraph, wherein the centrality values indicate relative importance of each paragraph within a thematic context of the plurality of paragraphs; and
calculating the similarity measures using cosine similarity between the intent vector and each of the encoded paragraph vectors.

5. The method of claim 1, wherein generating the graph representation comprises:
calculating pairwise similarity scores between the encoded paragraph vectors;
establishing edges between pairs of nodes when corresponding pairwise similarity scores exceed a predetermined threshold; and
assigning weights to the established edges based on the pairwise similarity scores.

6. The method of claim 1, wherein the iterative optimization process comprises:
maintaining a set of candidate sentence combinations from the plurality of paragraphs;
iteratively:
calculating a relevance score for each candidate combination based on similarity to the intent vector and semantic differences between sentences within the combination;
selecting candidate combinations having highest combined relevance and diversity scores; and
generating new candidate combinations based on the selected combinations until reaching a predetermined optimization criterion.

7. The method of claim 1, wherein generating the natural language summary comprises:
arranging the subset of sentences in a coherent order based on thematic relationships;
providing the subset of sentences as input to the second LLM along with the intent vector; and
generating, by the second LLM, the natural language summary that maintains semantic consistency with both the subset of sentences arranged in a coherent order and the intent vector.

8. The method of claim 1, wherein identifying the portions of the subset of sentences that contributed to the natural language summary comprises:
applying an explainability framework to analyse relationships between the subset of sentences and the natural language summary;
determining contribution weights for different portions of the subset of sentences; and
generating the explanatory indicators based on the determined contribution weights.

9. A system for providing intent-based information insights, comprising:
a processor;
a memory storing instructions that, when executed, causes the processor to perform operations comprising:
receiving an input question from a user;
identifying, using natural language processing techniques and a first large language model (LLM), an intent vector associated with the input question;
retrieving, from a document dataset, a plurality of paragraphs based on relevancy to the intent vector, wherein the document dataset comprises encoded paragraph vectors;
generating a graph representation of the plurality of paragraphs, wherein nodes of the graph representation represent the plurality of paragraphs and edges represent thematic relationships between the plurality of paragraphs;
determining importance scores for each paragraph of the plurality of paragraphs based on centrality values derived from the graph representation, and similarity measures between the intent vector and the encoded paragraph vectors corresponding to each paragraph;
selecting, through an iterative optimization process, a subset of sentences from the plurality of paragraphs based on the determined importance scores, wherein the iterative optimization process maximizes both relevance to the intent vector and content diversity among the subset of sentences;
generating, using a second LLM, a natural language summary based on the subset of sentences; and
outputting, to the user, the natural language summary with explanatory indicators identifying portions of the subset of sentences that contributed to the natural language summary.

10. The system of claim 9, wherein the operations further comprise preprocessing, prior to storing in the document dataset, a plurality of documents to generate the encoded paragraph vectors, wherein preprocessing comprises:
converting each document of the plurality of documents into plain text;
segmenting each document into a respective set of paragraphs;
generating, using a sentence encoder model, vector representations for each paragraph; and
storing the vector representations as the encoded paragraph vectors in the document dataset.

11. The system of claim 10, wherein preprocessing the plurality of documents further comprises:
identifying and removing non-textual elements from each document;
normalizing text formatting across the plurality of documents; and
filtering out duplicate paragraphs prior to generating the vector representations.

12. The system of claim 9, wherein determining the importance scores comprises:
applying a graph centrality algorithm to the graph representation to calculate the centrality values for each paragraph, wherein the centrality values indicate relative importance of each paragraph within a thematic context of the plurality of paragraphs; and
calculating the similarity measures using cosine similarity between the intent vector and each of the encoded paragraph vectors.

13. The system of claim 9, wherein generating the graph representation comprises:
calculating pairwise similarity scores between the encoded paragraph vectors;
establishing edges between pairs of nodes when corresponding pairwise similarity scores exceed a predetermined threshold; and
assigning weights to the established edges based on the pairwise similarity scores.

14. The system of claim 9, wherein the iterative optimization process comprises:
maintaining a set of candidate sentence combinations from the plurality of paragraphs;
iteratively:
calculating a relevance score for each candidate combination based on similarity to the intent vector and semantic differences between sentences within the combination;
selecting candidate combinations having highest combined relevance and diversity scores; and
generating new candidate combinations based on the selected combinations until reaching a predetermined optimization criterion.

15. The system of claim 9, wherein generating the natural language summary comprises:
arranging the subset of sentences in a coherent order based on thematic relationships;
providing the subset of sentences as input to the second LLM along with the intent vector; and
generating, by the second LLM, the natural language summary that maintains semantic consistency with both the subset of sentences arranged in a coherent order and the intent vector.

16. The system of claim 9, wherein identifying the portions of the subset of sentences that contributed to the natural language summary comprises:
applying an explainability framework to analyse relationships between the subset of sentences and the natural language summary;
determining contribution weights for different portions of the subset of sentences; and
generating the explanatory indicators based on the determined contribution weights.
